(19) United States
(12) Patent Application Publication
(10) Pub. No.: US 2016/0178806 A1
(43) Pub. Date: Jun. 23, 2016

(54) OPTICAL MEMBER AND IMAGE PICKUP APPARATUS

(71) Applicant: CANON KABUSHIKI KAISHA, Tokyo (JP)

(72) Inventors: Akiko Takei, Fujisawa-shi (JP); Akira Sugiyama, Yokohama-shi (JP); Norishige Kakegawa, Tokyo (JP); Kenji Takashima, Numazu-shi (JP); Zuyi Zhang, Yokohama-shi (JP); Yoshinori Kotani, Yokohama-shi (JP); Naoyuki Koketsu, Komae-shi (JP)

(73) Assignee: Canon Kabushiki Kaisha, Tokyo (JP)

(21) Appl. No.: 14/392,283

(22) PCT Filed: May 23, 2014
(86) PCT No.: PCT/JP2014/064553

§ 371 Date: Dec. 26, 2015

(30) Foreign Application Priority Data
Jun. 28, 2013 (JP) 2013-136160

(51) Int. Cl. G02B 1/118; G02B 1/113; G02B 1/14

(52) U.S. Cl. CPC G02B 1/118; G02B 1/14; G02B 1/113

(57) ABSTRACT

There are provided an optical member having a low reflectance and a good dustproof property and an image pickup apparatus.

A plurality of projections are formed on a surface of a low-refractive-index layer disposed on a base and having a refractive index lower than that of the base so that a distance between peaks of the projections is 50 nm or more and 600 nm or less. An occupied area percentage at a depth of 15 nm in a direction toward the base from a peak farthest from the base among the peaks of the projections is 40% or less. An average of minor axis lengths of the projections at a depth of 5 nm or more and 15 nm or less in the direction is 15 nm or more.

### TECHNICAL FIELD

The present invention relates to an optical member including a low-refractive-index layer on a base and an image pickup apparatus including the optical member.

### BACKGROUND ART

In image pickup apparatuses such as digital cameras, an image pickup element such as a charge-coupled device (CCD) sensor or a complementary metal oxide semiconductor (CMOS) sensor receives imaging light beams and outputs photoelectrically converted signals. The signals are converted into image data, and the data is stored in a recording medium such as a memory card. In such image pickup apparatuses, an optical filter such as a low-pass filter or an infrared cut filter is disposed on the object side of the image pickup element.

In digital cameras, mechanically operating parts such as a shutter are disposed near an optical filter, and foreign matter such as dust generated from the operating parts may adhere to the optical filter. When a lens is replaced, dust and the like present outside the digital camera may enter the main body of the digital camera through an aperture of a lens mount and adhere to the optical filter. If dust adheres to the optical filter, portions to which the dust adheres are taken in an image as black spots, which may degrade the quality of the image.

PTL 1 discloses that a foreign matter adhesion-preventing film composed of a material containing fluorine is formed on the surface of an optical filter in order to suppress the adhesion of dust. PTL 2 discloses that a dustproof film having a fine uneven structure constituted by a petaloid alumina film is formed on a light transmissive member.

### CITATION LIST

### Patent Literature

PTL 1 Japanese Patent Laid-Open No. 2006-163275

PTL 2 Japanese Patent Laid-Open No. 2007-183366

### SUMMARY OF INVENTION

### Technical Problem

The foreign matter adhesion-preventing film described in PTL 1 improves the dustproof property, but increases the reflectance at the surface. The dustproof film described in PTL 2 does not stably provide a low reflectance and a good dustproof property because the dustproof film has low mechanical strength and thus the uneven structure is easily broken.

The present invention provides an optical member having a low reflectance and a good dustproof property and an image pickup apparatus.

### Solution to Problem

An optical member according to an aspect of the present invention includes a base and a low-refractive-index layer disposed on the base and having a refractive index lower than that of the base. A plurality of projections are formed on a surface of the low-refractive-index layer so that a distance between peaks of the projections is 50 nm or more and 600 nm or less. An occupied area percentage of the projections at a depth of 15 nm in a direction toward the base from a peak farthest from the base among the peaks of the projections is 40% or less. An average of minor axis lengths of the projections at a depth of 5 nm or more and 15 nm or less in the direction is 15 nm or more.

### Advantageous Effects of Invention

According to the present invention, there can be provided an optical member having a low reflectance and a good dustproof property and an image pickup apparatus.

### BRIEF DESCRIPTION OF DRAWINGS

FIGS. 1A and 1B schematically show an example of an optical member according to an embodiment of the present invention.

FIGS. 2A and 2B are diagrams for describing liquid bridge.

FIG. 3 shows an example of an optical member according to a first embodiment.

FIG. 4 is a diagram for describing porosity.

FIGS. 5A and 5B are diagrams for describing the pore size and skeleton size.

FIG. 6 shows an example of an optical member according to a second embodiment.

FIG. 7 shows an example of an optical member according to a third embodiment.

FIG. 8 schematically shows an example of a fourth embodiment.

FIG. 9 is a graph showing a relationship between occupied area percentage and adhesive force index.

### DESCRIPTION OF EMBODIMENTS

The present invention will now be described in detail on the basis of embodiments of the present invention. Well-known or publicly known techniques in the technical field concerned are applied to components that are not particularly illustrated or described in this specification.

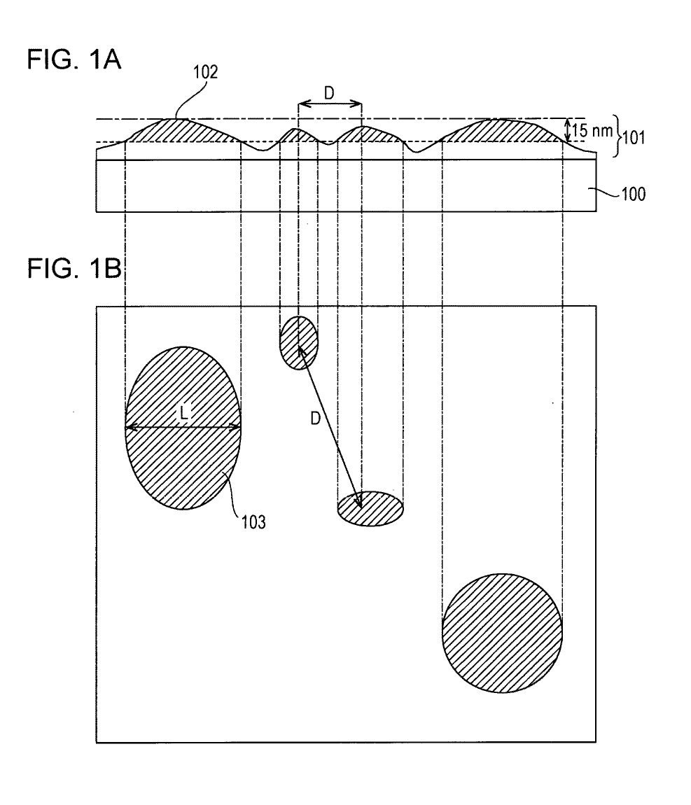

FIG. 1A is a cross sectional view taken in a direction perpendicular to a base 100 of an optical member according to an embodiment of the present invention. The optical member according to an embodiment of the present invention includes a base 100 and a low-refractive-index layer 101 that is disposed on the base 100 and has a refractive index lower than that of the base 100. A plurality of projections 102 are formed on a surface of the low-refractive-index layer 101, and thus an uneven structure is formed on a surface of the optical member. The minor axis length of each of the projections 102 decreases in a direction from the base 100 toward the surface of the low-refractive-index layer 101. The minor axis length of each of the projections 102 is the minimum distance among distances of straight lines that extend between any two points on the circumference of the projection 102 and pass through the center point in a cross section of the projection 102 taken in a direction parallel to the base 100.

By employing the above-described structure, the optical member according to an embodiment of the present invention is provided so that the refractive index of the optical member substantially decreases in a direction toward the surface of the low-refractive-index layer 101 of the base 100. Therefore, the reflectance can be reduced compared with a structure including only the base 100.

In the low-refractive-index layer 101 formed in each embodiment described below, the distance D between the peaks of two adjacent projections 102 is 50 nm or more and 600 nm or less (condition 1). In general, the size of dust in the air is 1 μm or more. Therefore, typical dust does not enter a portion between the projections 102 and the contact area between the projections 102 and the dust decreases. Consequently, the dustproof property of the optical member can be improved.

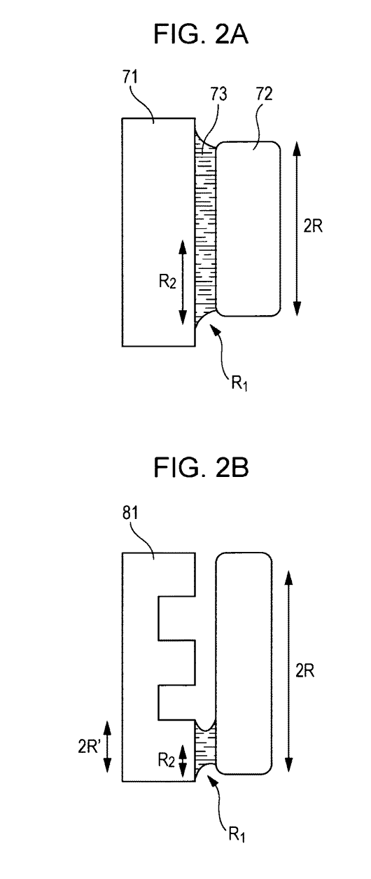

The inventors of the present invention assume the mechanism of improving the dustproof property to be as follows. In general, when no irregularities are formed on the surface, a force (adhesive force) that attracts dust is generated on the entire surface. On the other hand, in the optical member according to an embodiment of the present invention, such an adhesive force is generated only on the projections of the surface. This is described with reference to FIGS. 2A and 2B.

FIGS. 2A and 2B schematically show the adhesive force generated by liquid bridge. If a liquid 73 is present between an object 71 (or 81) and a dust 72, liquid bridge is formed between the object 71 (or 81) and the dust 72. The pressure is different between the inside (liquid side) and the outside (air side) of the air interface of the liquid bridge, and the pressure on the liquid side is lower than that on the air side. The pressure on the air side is equivalent to the atmospheric pressure and the pressure on the liquid side is a negative pressure, which is lower than the atmospheric pressure. The negative pressure P is represented by formula 1. The adhesive force F is a value obtained by multiplying the negative pressure P by the contact area S with the dust 72, which is represented by formula 2. Herein, R₁ represents a radius of curvature of the air interface of the liquid 73 formed between the object 71 (or 81) and the dust 72. R₂ represents a radius of a contact region between the object 71 (or 81) and the liquid 73. The contact area S is represented by a product of a surface area S₀ of the object 71 (or 81) and a ratio β of the projections on the surface. Furthermore, σ is a constant.

P−σ(1/R₁−1/R₂) Formula 1

F=PS=PS₀β Formula 2

FIG. 2A shows the case where the surface of the object 71 is a smooth surface. In FIG. 2A, R₂ corresponds to a radius R of the dust 72. FIG. 2B shows the case where the object 81 has a plurality of projections on its surface. In FIG. 2B, R₂ corresponds to a half width R′ of a projection. The projection corresponds to each of the projections 102 of the uneven structure on the surface of the low-refractive-index layer 101 in FIGS. 1A and 1B.

As is clear from the formula 1, the adhesive force is decreased by bringing R₂ close to R₁, that is, by decreasing the contact area between the object 71 (or 81) and the liquid 73.

As shown by the formula 2, the adhesive force can also be decreased by decreasing the ratio β of the projections on the surface. To decrease the ratio β, the width of the projections can be decreased or the distance between the projections can be increased.

The peaks of the plurality of projections 102 are not necessarily flat unlike the case shown in FIG. 2B. The projections 102 shown in FIG. 1A are exemplified. A peak farthest from the base 100 among the peaks of the plurality of projections 102 is referred to as the highest peak. The highest peak is the closest to the dust 72 in the low-refractive-index layer 101 (the object 81 in FIG. 2B).

Considering the surface profile of the dust 72 and the deformation of the dust 72 in contact, not only the peak of the projection 102 but also part of a side surface of the projection 102 contact the dust 72. In other words, the adhesive force generated by liquid bridge is related to a surface area of the peaks of the projections 102 and the side surfaces of the projections 102 around the peaks. Herein, the generation of the adhesive force by liquid bridge is limited to a portion of the peaks of the projections 102 and the side surfaces around the peaks, the portion being located within a depth of 15 nm from the highest peak in a direction toward the base 100. This is because, although there are some fluctuations based on humidity, in the uneven structure that satisfies the condition 1, the dust 72 does not contact side surfaces of the projections 102 located below a depth of about 15 nm from the highest peak in a direction toward the base 100.

In other words, the applicant of the present invention has found that the dustproof property can be improved by decreasing the surface area of the portion of the peaks of the projections 102 and the side surfaces around the peaks, the portion being located within a depth of 15 nm from the highest peak in a direction toward the base 100. Specifically, in the low-refractive-index layer 101 of the optical member according to an embodiment of the present invention, the occupied area percentage of the projections 102 is 40% or less at a depth of 15 nm from the highest peak in a direction toward the base 100 (condition 2). The condition 2 will be described below.

It is difficult to precisely calculate the surface area of the portion of the peaks of the projections 102 and the side surfaces around the peaks, the portion being located within a depth of 15 nm from the highest peak in a direction toward the base 100, because the surface profile needs to be precisely measured. Therefore, the applicant of the present invention defines the condition 2 using a cross-sectional area of the projections 102 in a cross section parallel to the base 100 at a depth of 15 nm from the highest peak in a direction toward the base 100. This definition is based on the positive correlation between the surface area and the cross-sectional area in which the minor axis length of each of the projections 102 decreases in a direction from the base 100 toward the surface of the low-refractive-index layer 101 as described above. That is, the decrease in the surface area of a contact region of the projections 102 with the dust 72 is equivalent to the decrease in the cross-sectional area. Thus, they can be replaced with each other in the evaluation of the dustproof property.

The occupied area percentage is a ratio of the total cross-sectional area of the projections 102 in a cross section parallel to the base 100 at a depth of 15 nm from the highest peak in a direction toward the base 100 per unit area of the base 100. The occupied area percentage will be specifically described below. FIG. 1B is a cross section taken in a direction parallel to the base 100 at a depth of 15 nm from the highest peak in a direction toward the base 100. In this cross section, the occupied area percentage is a ratio of the total area of diagonally shaded regions 103 to an area of a region (including the diagonally shaded regions 103) surrounded by a quadrilateral. The diagonally shaded regions 103 in FIG. 1B correspond to diagonally shaded portions in FIG. 1A. It will be described in Examples and Comparative Examples that the occupied area percentage of the projections 102 is 40% or less. By satisfying the condition 2, the adhesive force can be reduced.

To produce a dustproof effect, a certain degree of mechanical strength is required for the projections 102. This is because, if the mechanical strength is low, the projections 102 deform when an external force is exerted and thus an uneven structure having a good dustproof property cannot be maintained. Therefore, in the low-refractive-index layer 101 of the optical member according to an embodiment of the present invention, the average of the minor axis lengths L at a depth of 5 nm or more and 15 nm or less from the highest peak in a direction toward the base 100 is 15 nm or more (condition 3). By satisfying the condition 3, a necessary mechanical strength can be achieved. The reason why the cross section at a depth of 5 nm or more is employed is to increase the reliability of the average. This is because, in the cross section at a depth of less than 5 nm, the number of projections 102 is small or the minor axis lengths L are extremely small.

The average of minor axis lengths L is an average of minor axis lengths of projections 102 in a plurality of cross sections parallel to the base 100 at a depth of 5 nm or more and 15 nm or less from the highest peak in a direction toward the base 100. That is, regarding the minor axis lengths L of the projections 102 used to calculate the average, a plurality of lengths (e.g., three lengths for three cross sections at depths of 5 nm, 10 nm, and 15 nm) are measured for each of the plurality of projections 102. The average of all the lengths is defined as an average of minor axis lengths of the projections 102. If the height of the projections is less than 15 nm, the average of lengths is measured at an appropriate depth corresponding to the height of the projections.

The occupied area percentage and the minor axis lengths L of the projections 102 can be measured as follows. Specifically, the profile is measured in a scanning area of 1 μm×1 μm using a scanning probe microscope (hereafter abbreviated as an SPM) (E-Sweep manufactured by Seiko Instruments Inc.). In this study, the measurement is conducted with a DFM mode.

Subsequently, the data of the measured profile image is analyzed. First, it is checked that the measured profile image includes no singular points or measurement errors caused by, for example, foreign substances and measurement noises. Then, inclination is corrected to reduce the error resulting from the sample set. After the correction, the inclination is further corrected so that the height of the highest peak is symmetrical in horizontal and vertical directions. If necessary, an image processing for reducing the influence of noises and particles may be further performed.

In the image obtained through the above processes, the average of minor axis lengths of projections is calculated as follows. First, 5 or more cross sections parallel to the base 100 are selected at a depth of 5 nm or more and 15 nm or less from the highest peak in a direction toward the base 10U. To increase the reliability of the average to be calculated, the depths of the selected cross sections are spaced at intervals of 1 nm or more. In one of the cross sections (the above-mentioned scanning area), 20 or more minor axis lengths of the projections 102 are selected. Similarly, 20 or more minor axis lengths are selected in other cross sections. The minor axis lengths may be calculated with SPM image analysis software. In this study, “SPIP ver. 5.1.3” manufactured by Image Metrology was used. In a sliced cross section at a particular depth, the maximum distance between two points on the contour obtained by slicing a single projection is defined as the length of the projection. A value obtained by dividing the area of the projection (including a hole) by the length is calculated as a width. The average of the widths of a plurality of projections calculated with the software is used as a minor axis length. The average of the minor axis lengths of the projections 102 in the selected cross sections is defined as an average of the minor axis lengths of the projections 102 in a plurality of cross sections parallel to the base 100 at a depth of 5 nm or more and 15 nm or less from the highest peak in a direction toward the base 100. If it is difficult to perform the measurement with an SPM, a scanning microscope is used instead of the SPM and the data obtained from the observed image may be used.

The occupied area percentage is calculated as follows. The projections 102 at a depth of 15 nm from the highest peak in a direction toward the base 100 are selected. Binarization is performed between a region (diagonally shaded region 103 in FIG. 1B) corresponding to the projections 102 and the other region in the scanning area to calculate the total area of the region corresponding to the projections 102. A value obtained by dividing the total area of the region corresponding to the projections 102 by an area of the scanning area is defined as an occupied area percentage of the projections 102.

In order to improve the dustproof property, the average of the minor axis lengths of the projections 102 can be as low as possible. Specifically, the average of the minor axis lengths of the projections is preferably 60 nm or less and more preferably 45 nm or less.

### First Embodiment

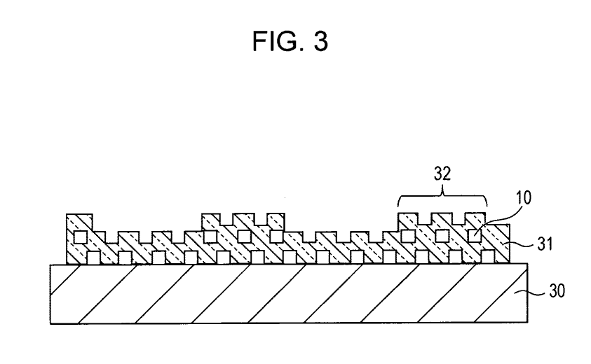

FIG. 3 is a schematic sectional view showing an example of an optical member according to this embodiment. The optical member according to this embodiment includes a base 30 and a porous layer 31 disposed on the base 30 and having a plurality of pores 10. The porous layer 31 corresponds to the low-refractive-index layer according to an embodiment of the present invention. A plurality of projections 32 are formed on a surface of the porous layer 31.

The porous layer 31 includes the plurality of pores 10 and thus has a refractive index lower than that of the base 30. Therefore, the reflectance is reduced compared with the structure including no porous layer because the reflection at the surface (porous layer side) of the optical member is suppressed. The projections 32 on the surface of the porous layer 31 satisfy the conditions 1 to 3 by being produced by a production method described below and thus have high strength and a good dustproof property.

The pores 10 of the porous layer 31 can be present not only in the porous layer 31 but also on the surface (the surface opposite the base 30). Since the uneven structure is also formed in the projections 32, an effect of scattering liquid bridge is further improved and a good dustproof property can be achieved.

The porous layer 31 may be composed of any known porous material as long as the porous layer 31 is within the scope of the present invention. The porous layer 31 can be, for example, a porous glass layer that uses a phase separation phenomenon, a porous silica layer such as mesoporous silica, or a porous polymer layer. In particular, a porous glass layer that uses spinodal phase separation and has a structure in which pores are three-dimensionally connected can be suitably used as the porous layer 31 because such a porous glass layer has both high reflectance and high strength.

The “phase separation” will be described on the basis of the case of borosilicate glass containing silicon oxide, boron oxide, and an alkali metal-containing oxide in a glass body. The “phase separation” means that the composition in glass before phase separation is separated into a phase (non-silicon-oxide-rich phase) containing an alkali metal-containing oxide and boron oxide in amounts larger than those in the composition before phase separation and a phase (silicon-oxide-rich phase) containing an alkali metal-containing oxide and boron oxide in amounts smaller than those in the composition before phase separation. The glass subjected to the phase separation is etched to remove the non-silicon-oxide-rich phase. Thus, a porous structure is formed in the glass body.

Phase separation is classified into spinodal phase separation and binodal phase separation. The pores of the porous glass obtained by spinodal phase separation are through-pores that extend from the surface to the inside. More specifically, the porous structure derived from spinodal phase separation is an “ant's nest” structure in which pores are three-dimensionally interconnected. The skeleton formed of silicon oxide corresponds to “walls” and the through-pores correspond to “cavities”.

The porous glass obtained by binodal phase separation has a structure in which independent pores each enclosed by a closed surface with a substantially spherical shape are discontinuously present in the skeleton formed of silicon oxide.

The pores derived from spinodal phase separation and the pores derived from binodal phase separation can be differentiated by morphological observation with an electron microscope. Occurrence of spinodal phase separation or binodal phase separation is determined by the composition of the glass body and the phase separation temperature.

A porous structure derived from spinodal phase separation has a three-dimensional network of through-pores extending from the surface to the inside and has porosity that can be controlled by changing the heat-treatment conditions. The porous structure has a three-dimensional intricate winding skeleton and a plurality of pores interconnected in three dimensions around the three-dimensional skeleton. The porous structure can therefore have high strength even at high porosity. Since the porous structure can have high surface strength even at high porosity, it is possible to provide an optical member that has excellent antireflection performance and high scratch resistance.

The porosity of the porous layer 31 is preferably 20% or more and 70% or less and more preferably 20% or more and 60% or less. If the porosity is less than 20%, the advantages of the porous layer 31 cannot be sufficiently utilized. If the porosity is more than 70%, the surface strength unfavorably tends to decrease. The porosity of the porous layer 31 in the range of 20% or more and 70% or less corresponds to a refractive index of 1.10 or more and 1.40 or less.

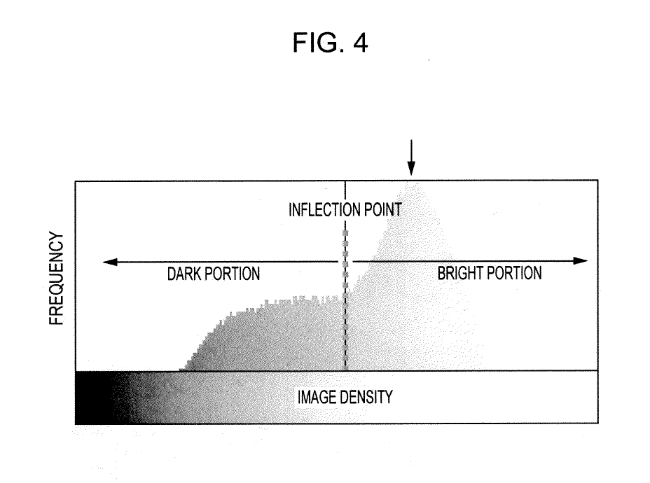

The porosity can be measured by the following measurement method. An electron micrograph image is binarized with respect to a skeleton and pores. Specifically, the surface of the porous layer 31 is observed with a scanning electron microscope (FE-SEM S-4800, manufactured by Hitachi, Ltd.) at an accelerating voltage of 5.0 kV at a magnification of 100,000 times (or 50,000 times) at which it is easy to observe the skeleton on a gray scale. The observed SEM image is stored and converted into a graph showing the frequency as a function of image density with image analysis software. FIG. 4 is a graph showing the frequency as a function of image density in the porous layer 31. The image density at the peak indicated by a down arrow in FIG. 4 corresponds to the skeleton on the front surface. A bright portion (skeleton) and a dark portion (pores) are binarized into black and white using an inflection point close to the peak as a threshold. The ratio of a black area to the entire area (the total of white and black areas) is determined for each of the black areas in the image. The ratios are averaged to determine porosity.

The pore size of the porous layer 31 is preferably 5 nm or more and 50 nm or less and more preferably 5 nm or more and 20 nm or less. If the pore size is less than 5 nm, the features of the structure of the porous layer 31 cannot be sufficiently utilized. If the pore size is more than 50 nm, the surface strength unfavorably tends to decrease. The pore size is more preferably 20 nm or less because light scattering is considerably suppressed. Furthermore, the pore size can be smaller than the thickness of the porous layer 31.

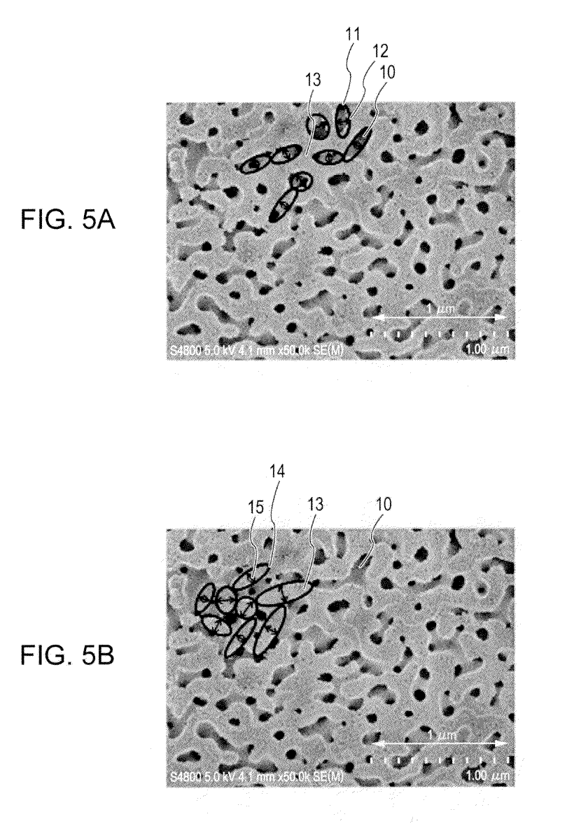

The pore size is defined as an average of minor axis lengths of ellipses corresponding to pores in a region of 5 μm×5 μm of any cross section of the porous layer 31. Specifically, as shown in FIG. 5A, the pore size is determined by calculating the average of minor axis lengths 12 of ellipses 11 corresponding to pores 10 using an electron micrograph of a surface of a porous glass layer formed as a result of spinodal phase separation. The average is determined from at least 30 measurements.

The skeleton size of the porous layer 31 is preferably 5 nm or more and 50 nm or less and more preferably 5 nm or more and 20 nm or less. It the skeleton size is more than 50 nm, light scattering markedly occurs, which considerably decreases transmittance. The skeleton size is more preferably 20 nm or less because light scattering is suppressed.

The skeleton size is defined as an average of minor axis lengths of ellipses corresponding to skeleton walls in a region of 5 μm×5 μm of any cross section of the porous layer 31. Specifically, as shown in FIG. 5B, the skeleton size is determined by calculating the average of minor axis lengths 15 of ellipses 14 corresponding to skeleton walls 13 using an electron micrograph of a surface of the porous layer 31 formed as a result of spinodal phase separation. The average is determined from at least 30 measurements.

It should be noted that light scattering is affected by various factors such as the thickness of an optical member and does not uniquely depend on the pore size and the skeleton size.

The thickness of the porous layer 31 is not particularly limited, but is preferably 0.1 μm or more and 20.0 μm or less and more preferably 0.1 μm or more and 10.0 μm or less. If the thickness is less than 0.1 μm, an effect produced by high porosity (low refractive index) is not achieved. If the thickness is more than 20.0 μm, the influence of scattering increases, which makes it difficult to use the porous layer 31 for an optical member.

The thickness of the porous layer 31 is determined by the following method. Specifically, a SEM image (electron micrograph) is taken with a scanning electron microscope (FE-SEMS-4800, manufactured by Hitachi, Ltd.) at an accelerating voltage of 5.0 kV. The thickness of the porous layer 31 on the base 30 is measured at 30 or more points on the image. The average of the thicknesses is used as the thickness of the porous layer 31.

The porous layer 31 may have a monolayer structure or a multi-layer structure as long as the surface (the surface opposite the base 30) of the porous layer 31 includes the plurality of projections 32 as described above. In the entire porous layer 31, the porosity can increase in a direction from the base 30 toward the surface of the porous layer 31 to further achieve an effect of low reflectance.

In addition to the members and structures described above, the optical member according to an embodiment of the present invention may further include layers for imparting various functions. For example, a water-repellent layer composed of a fluoroalkylsilane, an alkylsilane, or the like can be disposed to impart water repellency. A dustproof property that has not been achieved can be realized by employing the structure of the present invention. By controlling the surface properties of projections, a better dustproof property can be realized due to a combined effect of the structure and the surface properties.

The base 30 and the porous layer 31 are not necessarily in contact with each other, and an intermediate layer may be formed between the base 30 and the porous layer 31. The intermediate layer desirably has a refractive index between refractive indices of the base 30 and the porous layer 31. The intermediate layer may have a monolayer structure or a multi-layer structure in which the refractive index decreases in a direction from the base 30 toward the porous layer 31. The intermediate layer may be a non-porous layer.

The base 30 can be composed of any material suitable for the purpose. The base 30 can be composed of, for example, quartz glass or rock crystal in terms of transparency, heat resistance, and strength. The base 30 may have a layered structure composed of different materials. The base 30 may also be composed of a material for low-pass filters, infrared cut filters, and lenses. The base 30 is composed of a non-porous material.

The base 30 can be transparent. The transmittance of the base 30 is preferably 50% or more and more preferably 60% or more in a visible region (wavelength range of 450 nm or more and 650 nm or less). If the transmittance is less than 50%, some problems may be posed when the base 30 is used for an optical member. The haze of the base 30 can be 0.2% or less.

When the porous layer 31 is a porous glass layer formed as a result of phase separation, the porous layer 31 can be formed on the base 30 by a publicly known method. For example, the following processes may be performed in that order.

(1) a step of forming a glass powder layer containing a plurality of glass powder particles on a base 30
(2) a step of forming a mother glass layer by fusing the plurality of glass powder particles of the glass powder layer
(3) a step of forming a phase-separated glass layer by subjecting the mother glass layer to phase separation
(4) a step of forming a porous glass layer (porous layer 31) by etching the phase-separated glass layer
(5) a step of forming a plurality of projections 32 on a surface of the porous glass layer

Note that the step (5) may be performed after the step (4) or may be simultaneously performed together with the step (4).

(1) Step of forming glass powder layer

First, a glass powder layer containing a plurality of glass powder particles is formed on the base 30. The composition of the glass powder particles may be suitably set in accordance with the optical member. The glass powder layer is formed by any method that enables film formation, such as a printing method, a spin coating method, or a dip coating method. Among them, a printing method that uses screen printing is suitably used as a method for forming a glass powder layer having a desired glass composition.

Hereafter, a description will be made on the basis of a typical method that uses screen printing. In screen printing, glass powder particles in the form of a paste are prepared and printed with a screen printing machine. Therefore, a paste of the glass powder particles needs to be prepared.

A base glass to be formed into glass powder particles can be produced by a publicly known method. For example, the base glass can be produced by heat-melting raw materials containing component sources and, if necessary, shaping the molten product into a desired form. Any glass powder particles may be used as long as they are phase-separable glass powder particles.

The heating temperature during the heat melting may be suitably set in accordance with the composition of the raw materials and the like, but is preferably 1350° C. or higher and 1450° C. or lower and particularly preferably 1380° C. or higher and 1430° C. or lower.

In order to use the base glass in the form of a paste, the base glass is converted into glass powder particles. The glass powder particles may be produced by any publicly known method. Examples of the method include liquid-phase pulverization using a bead mill and gas-phase pulverization using a jet mill. In addition to the glass powder particles, the paste contains a thermoplastic resin, a plasticizer, and a solvent.

The content of the glass powder particles in the paste is preferably 30.0% by weight or more and 90.0% by weight or less and more preferably 35.0% by weight or more and 70.0% by weight or less.

The thermoplastic resin contained in the paste can increase the film strength after drying and impart flexibility to the film. Examples of the thermoplastic resin include polybutyl methacrylate, polyvinyl butyral, polymethyl methacrylate, polyethyl methacrylate, and ethylcellulose. These thermoplastic resins may be used alone or in combination of two or more.

Examples of the plasticizer contained in the paste include butyl benzyl phthalate, dioctyl phthalate, diisooctyl phthalate, dicapryl phthalate, and dibutyl phthalate. These plasticizers may be used alone or in combination of two or more.

Examples of the solvent contained in the paste include terpineol, diethylene glycol monobutyl ether acetate, and 2,2,4-trimethyl-1,3-pentanediol monoisobutyrate. These solvents may be used alone or in combination of two or more.

The paste can be prepared by kneading these materials at a predetermined ratio. The thus-prepared paste is applied onto a base by screen printing to form a glass powder layer. Specifically, the paste is applied and is then dried to remove the solvent in the paste, thereby forming a glass powder layer.

The temperature and time for removing the solvent by drying can be suitably changed in accordance with the type of solvent. However, it is desirable to dry the paste at a temperature lower than the decomposition temperature of the thermoplastic resin. If the drying temperature is higher than the decomposition temperature of the thermoplastic resin, the glass particles are not fixed and the glass powder layer tends to have defects.

Use of the base 30 suppresses the strain of the glass layer caused by heat treatment in the phase separation step and facilitates the thickness control of the porous glass layer.

The softening temperature of the base 30 is preferably higher than or equal to the heating temperature in the phase separation step described below (phase separation temperature) and more preferably higher than or equal to the phase separation temperature +100° C. In the case where the base 30 is made of crystals, however, the softening temperature of the base 30 is the melting temperature. When the softening temperature is lower than the phase separation temperature, the base 30 may be unfavorably distorted in the phase separation step.

### (2) Step of Forming Mother Glass Layer

The glass powder layer is then heated to fuse the glass powder particles, thereby forming a phase-separable mother glass layer on the base 30. The term “phase-separable” means that the phase separation described above can occur at a certain heating temperature.

The glass powder particles can be fused by performing a heat treatment at a temperature higher than or equal to the glass transition temperature Tg (° C.). In the phase-separable glass powder particles, a heat treatment is performed at a temperature higher than or equal to the crystallization temperature Tc (° C.), whereby voids in the film are reduced and a uniform film is formed.

The fusing temperature is determined in accordance with the type of glass and thus does not limit the present invention. The fusing temperature suitably set in typical phase-separable glasses is 600° C. or higher and 1200° C. or lower. However, in the present invention, the fusing temperature is higher than or equal to the crystallization temperature and 1200° C. or lower in order to suppress the formation of voids. If the fusing temperature is higher than 1200° C., the composition of glass changes and phase separation sometimes does not occur.

The heating time required for fusing the glass powder particles can be suitably set in accordance with the heating temperature, but can be 5 minutes or longer and 50 hours or shorter.

The heating rate until the fusing temperature can be suitably set in accordance with the mother glass layer.

A publicly known heat treatment method can be used as a heating method for fusion. The heat treatment method may involve the use of an electric furnace, an oven, or infrared radiation. Any heating methods such as convective, radiant, and electric heating methods can be employed. In particular, an infrared radiation furnace is suitably used in terms of facilitation of fusion of the glass powder particles.

When the firing atmosphere is an oxygen-rich atmosphere (an oxygen concentration of 50% or more), a binder resin component is effectively decomposed, and thus voids resulting from the binder resin component in the film can be reduced. The solvent in the paste may be removed simultaneously in the fusion of the glass powder layer.

After the mother glass layer is formed, a surface of the mother glass layer may be flattened. Specifically, it is desirable to polish a surface of the mother glass layer. The flattening may be performed after a phase-separated glass layer described below is formed. Surface flattening may be performed only after the mother glass layer is formed or only after the phase-separated glass layer is formed, or both after the mother glass layer is formed and after the phase-separated glass layer is formed.

### (3) Step of Forming Phase-Separated Glass Layer

Next, the mother glass layer is subjected to phase separation to form a phase-separated glass layer on the base 30. More specifically, the phase separation step of forming a phase-separated glass layer is performed at a temperature of 450° C. or higher and 750° C. or lower for 3 hours or longer and 100 hours or shorter. The heating temperature in the phase separation step is not necessarily fixed, and may be continuously changed or may include different temperature stages. The porosity of the porous glass layer described below can be adjusted by controlling the phase separation treatment time.

Since optical members require a very low haze, the porous glass layer for use in optical members can have a small skeleton size and a very fine structure of pores to decrease the haze.

Heating in the phase separation treatment may be performed by a publicly known heat treatment method. The heat treatment method may involve the use of an electric furnace, an oven, or infrared radiation. Any heating methods such as convective, radiant, and electric heating methods can be employed.

### (4) STEP OF FORMING POROUS GLASS LAYER

Next, the phase-separated glass layer is etched to form the porous glass layer on the base 30. The non-silicon-oxide-rich phase in the phase-separated glass layer can be removed by an etching treatment while a silicon-oxide-rich phase is left. The silicon-oxide-rich phase forms a skeleton of the porous glass layer, and portions from which the non-silicon-oxide-rich phase has been removed form pores of the porous glass layer.

The etching treatment for removing the non-silicon-oxide-rich phase is generally a treatment (wet etching) in which a soluble non-silicon-oxide-rich phase is eluted by bringing it into contact with an aqueous solution. A glass is generally brought into contact with the aqueous solution by immersing the glass in the aqueous solution. However, any method for bringing a glass into contact with an aqueous solution can be employed. For example, an aqueous solution is applied to a glass. An aqueous solution required for the etching treatment may be a known solution that can elute the non-silicon-oxide-rich phase, such as water, an acid solution, or an alkaline solution. For some applications, a plurality of processes of bringing a glass into contact with an aqueous solution may be selected.

The aqueous solution can be a solution of an acid, for example, an inorganic acid such as hydrochloric acid or nitric acid. The acid solution can be normally an aqueous solution containing water as a solvent. The concentration of the acid solution may be normally in the range of 0.1 mol/L or more and 2.0 mol/L or less. In an acid treatment process using the acid solution, the acid solution temperature may be in the range of 15° C. or higher and 100° C. or lower, and the processing time may be in the range of 1 hour or longer and 500 hours or shorter.

Depending on the glass composition and the production conditions, a silicon oxide layer having a thickness of 20 nm or more and 30 nm or less may be formed on a glass surface after the phase separation treatment. The silicon oxide layer inhibits etching. The silicon oxide layer on the surface can be removed by polishing or an acid or alkaline treatment.

In particular, polishing can be employed because the flatness of a surface of an optical member is achieved and the haze (scattering) can be reduced.

The treatment with an acid solution or an alkaline solution can be followed by a water treatment. A water treatment can suppress the deposition of residual components onto the skeleton of the porous glass layer and tends to increase the porosity of the porous layer and suppress scattering.

The temperature in the water treatment can generally be in the range of 15° C. or higher and 100° C. or lower. The time for the water treatment can be suitably determined in accordance with, for example, the composition and size of the glass to be treated and may be in the range of 1 hour or longer and 50 hours or shorter.

### (5) Step of Forming a Plurality of Projections on Surface of Porous Glass Layer

Finally, a plurality of projections 32 are formed on a surface of the porous glass layer. This step may be performed simultaneously with the wet etching conducted in the step of forming a porous glass layer or may be performed by any known method such as dry etching or mechanical polishing after the step of forming a porous glass layer. In particular, overetching can be performed in the step of forming a porous glass layer. The term “overetching” means that part of the skeleton is excessively dissolved by wet etching. As a result of this overetching, an uneven structure (projections 32) is formed on the surface of the porous glass layer.

In the production method according to this embodiment, since the glass powder particles are fused, a composition difference due to the grain boundaries between the glass powder particles and an uneven structure derived from the glass powder particles are believed to tend to remain on the surface of the phase-separated glass layer. When such a phase-separated glass layer is subjected to overetching, the degree of overetching varies due to the composition difference and the uneven structure, and thus a plurality of projections 32 can be easily formed on the surface of the porous glass layer. Furthermore, as a result of the overetching, part of the skeleton is dissolved, which decreases the density of the skeleton of the porous glass layer. This increases the porosity and thus decreases the refractive index of the porous glass layer. Consequently, a porous glass layer having a lower refractive index than typical porous glass layers can be realized.

To satisfy the conditions 1 to 3 of the projections, the overetching is performed under the following conditions. That is, in the step of forming a porous glass layer, the etching temperature may be increased or the etching time may be lengthened. Specifically, in the acid treatment process that uses an acid solution, the acid solution temperature may be in the range of 80° C. or higher and 100° C. or lower or the treatment time may be in the range of 20 hours or longer and 500 hours or shorter. In particular, the etching temperature can be increased because a high etching rate is achieved and the projections 32 are easily formed on the surface of the porous glass layer in accordance with the surface profile of the phase-separated glass layer.

The plurality of projections 32 are formed on the surface of the porous glass layer by the following method. That is, in the above-described step (2), a plurality of projections 32 are formed on the surface of the mother glass layer, and the steps (3) and (4) are performed while the projections 32 on the surface are retained. In other words, a method for producing the optical member according to this embodiment includes the following steps.

(1) A Step of Forming a Glass Powder Layer Containing a plurality of glass powder particles on a base 30
(2A) a step of forming a mother glass layer by fusing the plurality of glass powder particles of the glass powder layer
(2B) a step of forming a plurality of projections on a surface of the mother glass layer
(3′) a step of forming a phase-separated glass layer including the plurality of projections by subjecting the mother glass layer to phase separation
(4′) a step of forming a porous glass layer including the plurality of projections 32 by etching the phase-separated glass layer

The step (2A) and the step (2B) may be simultaneously performed or the step (2B) may be performed after the step (2A). When the step (2A) and the step (2B) are simultaneously performed, a plurality of projections that satisfy the conditions 1 to 3 can be formed on the surface of the mother glass layer by suitably controlling the composition of the glass powder particles, the particle diameter and particle size distribution of the glass powder particles, and the fusion conditions (e.g., heat treatment temperature, heat treatment time, and heating rate) of the glass powder particles. For example, by increasing the heating rate, the plurality of projections can be formed on the surface of the mother glass layer. When the step (2B) is performed after the step (2A), a plurality of projections can be formed on the surface of the mother glass layer by performing dry etching or mechanical polishing.

As described above, when a plurality of projections are formed on the surface of the mother glass layer before the phase separation treatment, the projections 32 are formed on the surface of the porous glass layer by only performing a typical phase separation treatment and etching treatment.

### Second Embodiment

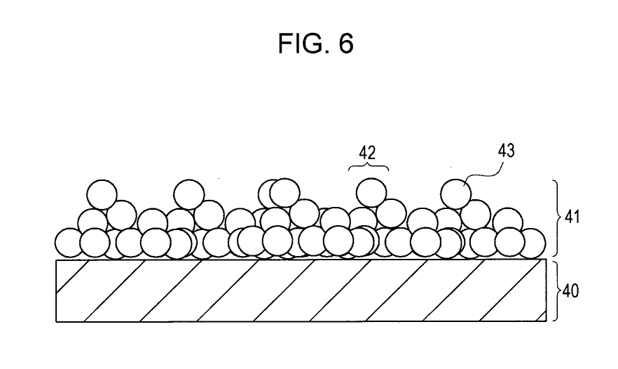

FIG. 6 is a schematic sectional view showing an optical member according to this embodiment. As shown in FIG. 6, the optical member according to this embodiment includes a base 40 and a particle layer 41 disposed on the base 40 and containing particles 43 having a refractive index lower than that of the base 40. The particle layer 41 includes a plurality of projections 42 on its surface. The particle layer 41 corresponds to the low-refractive-index layer of the optical member according to an embodiment of the present invention.

Since the particle layer 41 has a refractive index lower than that of the base 40, the reflection at the surface (the interface between the particle layer 41 and the air) of the optical member is suppressed compared with a structure including no particle layer 41. Thus, the reflectance is reduced. Furthermore, since the projections 42 on the surface of the particle layer 41 satisfy the conditions 1 to 3 under the production conditions described below, high strength and a good dustproof property can be achieved.

The difference in refractive index between the particle layer 41 and the base 40 is preferably 0.10 or more and more preferably 0.20 or more. When the difference in refractive index is in the above range, the reflection at the surface can be more efficiently suppressed.

The thickness of the particle layer 41 is preferably 50 nm or more and 400 nm or less and more preferably 200 nm or less. If the thickness is less than 50 nm, it is difficult to form projections 42 having a size that contributes to a dustproof property and thus a good dustproof property is not achieved. If the thickness is more than 400 nm, scattering considerably occurs. The thickness of the particle layer 41 can be measured by the same method as in the porous layer 31 in the first embodiment.

The particles 43 may be any particles as long as they have a refractive index lower than that of the base 40. The difference in refractive index between the particles 43 and the base 40 is preferably 0.10 or more and more preferably 0.20 or more. The particle layer 41 containing the particles 43 in the above range can more efficiently suppress the reflection at the surface.

Examples of a material suitably used for the particles 43 include silicon oxide, aluminum oxide, titanium oxide, zirconium oxide, zinc oxide, cerium oxide, and yttrium oxide. The particles 43 may be particles obtained by combining two or more of the above oxides. Furthermore, the particles 43 may be composed of polystyrene, silicone, nylon, polypropylene, polyethylene terephthalate, styrene acrylic resin, polyimide, and polylactic acid.

To achieve a lower refractive index, the particles 43 can be suitably hollow particles that are composed of the above material or particles that are composed of the above material and each have pores on the surface thereof. Specifically, particles having a structure including pores with a size of 1 nm or more and 10 nm or less or particles (hollow particles) having a hollow structure may be used. In particular, hollow particles can be employed in terms of environmental stability.

By modifying the surface, particles 43 each having a surface whose chemical state is changed can also be used. Specifically, surfaces of inorganic oxide particles may be subjected to organic modification with a silane coupling agent or the like.

The particle diameter of the particles 43 can be 10 nm or more and 100 nm or less. If the particle diameter is less than 10 nm, it tends to be difficult to form the projections 42 on the surface of the optical member. If the particle diameter is more than 100 nm, the size of the projections 42 (the width of the projections 42) increases and thus it tends to be difficult to achieve a low adhesive force at contact points with dust.

The particle layer 41 may contain a binder for bonding the plurality of particles 43, which is desirable because the strength of the particle layer 41 tends to be increased by the binder.

Any binder may be used as long as the refractive index of the particle layer 41 is lower than that of the base 40. Specifically, the binder may be composed of a monomer, a dimer, an organic polymer of at least a trimer, or an inorganic polymer prepared by a sol-gel process. Examples of the organic polymer include acrylic acid esters, methacrylic acid esters and derivatives thereof, and epoxy resins.

The binder may also be composed of an inorganic material prepared by a sol-gel process. A specific example of the inorganic material is silicon oxide. Other examples of the inorganic material include materials obtained by combining a high-refractive-index material such as aluminum oxide, titanium oxide, or zirconium oxide with a low-refractive-index material such as silicon oxide or magnesium fluoride.

A polymer having a low degree of polymerization can be suitably used as a binder that provides ease of filling and ease of control of a filling factor. In addition to the binder, a solvent for adjusting viscosity and surface tension may be added. To increase the adhesiveness between the particles 43, a silane coupling agent may be added. The particle layer 41 may contain at least one material for adjusting the refractive index, in addition to the particles 43. To provide the multiple functions described above, various materials may be combined with each other.

When the particles are assumed to have a weight-percent concentration Cp and the binder is assumed to have a weight-percent concentration Cb, the component ratio Cp/Cb can be more than 3.0. When the component ratio Cp/Cb is more than 3.0, the ratio of the binder to the particles is small. Therefore, the projections 42 are easily formed on the surface of the particle layer 41 due to their particle shape, which tends to provide a good dustproof property.

In the present invention, each of the projections 42 can be constituted by a plurality of particles 43. The presence of a plurality of particles 43 at one contact point produces combined effects of suppressing liquid bridge by the projections 42 and suppressing liquid bridge by reducing the contact area as a result of decreasing the number of contact points at the projections 42. Consequently, the optical member according to an embodiment of the present invention can exhibit a good dustproof property.

The base 40 and the particle layer 41 are not necessarily in contact with each other, and an intermediate layer may be formed between the base 40 and the particle layer 41. The intermediate layer desirably has a refractive index between refractive indices of the base 40 and the particle layer 41. The presence of the intermediate layer tends to realize a low reflectance at the surface of the optical member. The intermediate layer may have a monolayer structure or a multi-layer structure in which the refractive index decreases in a direction from the base 40 toward the particle layer 41. The same base as in the first embodiment can be used as the base 40.

The optical member according to an embodiment of the present invention may be produced by any method as long as the optical member that satisfies the scope of the present invention can be produced. The production method according to an embodiment of the present invention will be described below based on an example in which silicon oxide particles (silica particles) are used as the particles 43 of the particle layer 41. However, the production method according to an embodiment of the present invention is not limited thereto.

In the present invention, a particle layer 41 containing silica particles is suitably formed on the base 40 by, for example, spin coating, dip coating, spraying, or capillary coating.

A method for producing the optical member according to an embodiment of the present invention will now be described in detail based on an example that uses spin coating.

A coating solution for forming a particle layer 41 is prepared. A particle-dispersed solution prepared by dispersing, in a solvent, silica particles having a lower refractive index than the base 40 can be used as the coating solution. The viscosity and concentration of the coating solution can be suitably adjusted in accordance with the optical member.

The weight-percent concentration Cp of the silica particles is preferably 4.0 wt % or more and more preferably 5.0 wt % or more. When the weight-percent concentration Cp is within the above range, the aggregation of the silica particles appropriately proceeds during drying. Consequently, the projections 42 that satisfy the conditions 1 to 3 and thus exhibit a good dustproof property tend to be formed on the surface of the particle layer 41.

In order to maintain a certain level of dispersion of the silica particles, a solvent having a high affinity for silica particles can be suitably used as the solvent used to disperse the silica particles. If the affinity is low, the silica particles sometimes aggregate and precipitate. Specific examples of the solvent include water solvents, organic solvents, and mixed solvents containing water solvents and organic solvents. Pure water or the like can be used as the water solvent. Examples of the organic solvents include alcohols such as methanol and ethanol; ketones such as methyl ethyl ketone, acetone, and acetylacetone; and hydrocarbons such as hexane and cyclohexane.

The boiling point of the solvent is preferably 100° C. or higher and more preferably 130° C. or higher to form ideal projections 42. Specifically, 2-ethoxyethanol (ethyl cellosolve) or the like can be suitably used. The solvent having a boiling point in the above range is evaporated at an appropriate rate during drying. Consequently, the aggregation of the silica particles proceeds and projections 42 having a good dustproof property tend to be formed.

To control the dispersibility of the silica particles, an additive may be suitably added to the coating solution.

The coating conditions for the coating solution are not particularly limited as long as the optical member within the scope of the present invention can be produced, and can be changed in accordance with the purpose.

The spin coating conditions do not limit the present invention. However, the rotational speed in spin coating is desirably not suddenly increased to the rotational speed at which film formation is achieved, and the rotation can be performed for a certain period of time at a rotational speed lower than the rotational speed at which film formation is achieved. Specifically, the rotation may be performed for a certain period of time at a constant low rotational speed or the rotational speed is gradually increased to lengthen the time for which the rotation is performed at a low rotational speed. In the latter case, specifically, the rate of increase in the rotational speed can be 2000 rpm/s or less. Note that the low rotational speed is in the range of 100 rpm or more and 3000 rpm or less. The time for which the rotation is performed at a low rotational speed can be 1 second or longer.

In the case where the rotation at a low rotational speed is not performed, the solvent is uniformly evaporated during film formation, and thus it tends to be difficult to form the projections 42 on the surface of the particle layer 41. In particular, in the case where a coating solution containing two or more types of solvents having different boiling points is used and the rate of increase in the rotational speed is 2000 rpm/s or less, the viscosity of the coating solution is believed to change stepwise depending on the boiling points of the solvents when the rotational speed is increased. Consequently, the projections 42 that satisfy the conditions 1 to 3 tend to be formed on the surface of the particle layer 41.

The temperature at which the coating solution is applied by spin coating can be suitably changed in accordance with desired projections 42 of the optical member. Specifically, the temperature can be in the range of 10° C. or higher and 40° C. or lower in terms of ease of control.

To increase the physical strength of the optical member, a certain amount of heat is applied to melt the surfaces of the silica particles, whereby silica particles adjacent to each other may be bonded to each other. Alternatively, to increase the physical strength of the optical member, a binder-containing solution containing a binder for bonding particles may be applied before or after the application of the particle-dispersed solution.

The viscosity, concentration, and the like of the binder-containing solution can be suitably adjusted in accordance with the optical member. The weight-percent concentration Cb of the binder is preferably 2.0 wt % or less and more preferably 1.0 wt % or less. When the weight-percent concentration Cb is within the above range, fine projections 42 based on the particle shape tend to be formed after drying and thus projections 42 that exhibit a good dustproof property are easily formed.

To facilitate the dispersion/dissolution of the binder, a solvent having a high affinity for the binder can be suitably used as the solvent for dispersing the binder. If the affinity is low, the binder sometimes aggregate and precipitate. The solvent can be suitably selected in accordance with the binder. Specific examples of the solvent include water solvents, organic solvents, and mixed solvents containing water solvents and organic solvents. To control the dispersion and solubility of the binder, an additive may be suitably added to the binder-containing solution.

The temperature at which the binder-containing solution is applied is not particularly limited, but may be generally 10° C. or higher and 40° C. or lower in terms of ease of control of film formation.

The particle-dispersed solution and the binder-containing solution may be separately applied or a mixture of the particle-dispersed solution and the binder-containing solution may be applied. After the application of the particle-dispersed solution and the binder-containing solution, a drying process may be performed to control the volatilization of solvent components.

To increase the strength of the particle layer 41, a heat treatment process can be performed after the film formation of the coating solution. The heat treatment temperature can be a temperature at which the binder does not decompose. When the particles 43 are particles having pores, the heat treatment needs to be performed under the conditions that the pores do not disappear due to the heat treatment and thus the refractive index does not considerably increase. For example, in the case of an inorganic material prepared by a sol-gel process, a heat treatment is performed at a temperature of 50° C. or higher and 700° C. or lower, whereby the polycondensation of the inorganic material can be caused to proceed to increase the strength. The heat treatment time can be suitably set in accordance with the material.

A publicly known heat treatment method can be used. The heat treatment method may involve the use of an electric furnace, an oven, or infrared radiation. Any heating methods such as convective, radiant, and electric heating methods can be employed.

The particle layer 41 may be formed by fusing the plurality of particles 43 without using a binder. In this case, voids are formed between the particles and the particle layer 41 can also be regarded as the porous layer in the first embodiment. An example of a production method for this structure will be described below.

That is, an organic polymer containing silica particles is subjected to film formation on a base, and a heat treatment is performed at a temperature higher than or equal to the softening temperature of the silica particles. Consequently, the organic polymer can be decomposed and the silica particles can be bound to form a particle layer. The heating temperature in the heat treatment is not necessarily fixed, and may be continuously changed or may include different temperature stages. The uneven structure of the particle layer is believed to be formed by the following mechanism. The organic polymer is decomposed from its surface by the heat treatment while at the same time the particles uniformly dispersed in the film gradually move under their own weight. This results in a state in which particles are densely present on the base side and sparsely present on the surface side, and the particles are bound with each other.

Any possible production method such as printing, vacuum deposition, sputtering, spin coating, or dip coating is employed as a method for forming a film composed of the silica particles contained in the organic polymer.

The organic polymer is not particularly limited as long as it is decomposed by being heated to a temperature higher than or equal to the softening temperature (about 600° C.) of the silica particles in the air. Examples of the organic polymer that can be used include polyvinyl alcohol, polyvinylpyrrolidone, polyvinyl butyral, polymethyl methacrylate, polybutyl methacrylate, polyethyl methacrylate, and ethylcellulose. These thermoplastic resins can be used alone or in combination of two or more.

Examples of a solvent contained when a wet process is used for forming a film include water, isopropyl alcohol, acetone, methanol, ethanol, terpineol, diethylene glycol monobutyl ether acetate, and 2,2,4-trimethyl-1,3-pentanediol monoisobutyrate. The solvent is also not particularly limited as long as it is decomposed by being heated to a temperature higher than or equal to the softening temperature of the silica particles in the air. These solvents can be used alone or in combination of two or more.

The ratio of the silica particles is preferably 5.0 wt % or more and 60.0 wt % or less and more preferably 5.0 wt % or more and 25.0 wt % or less relative to the total weight. When the ratio of the silica particles is within the above range, projections that satisfy the conditions 1 to 3 can be formed on the surface of the particle layer.

In addition to the members and structures described above, the optical member according to an embodiment of the present invention may further include layers for imparting various functions. For example, in order to impart water repellency, a water-repellent film composed of a fluoroalkylsilane, an alkylsilane, or the like can be disposed on the surface of the particle layer 41 so as to follow the shape of the projections 42. In order to improve the adhesiveness to the base 40, an adhesive layer or a primer layer may be disposed between the particle layer 41 and the base 40.

### Third Embodiment

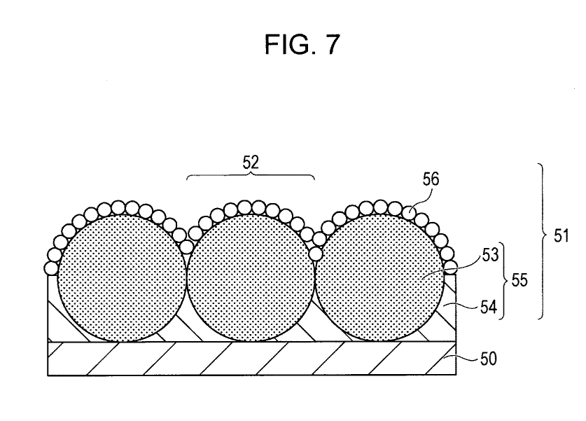

FIG. 7 is a sectional view showing an optical member according to this embodiment. The optical member according to this embodiment includes a base 50, an undercoat layer 55 disposed on the base 50 and containing a plurality of first particles 53, and a plurality of second particles 56 having a particle diameter smaller than that of the first particles 53 and a refractive index lower than or equal to that of the first particles 53. A particle layer constituted by the second particles 56 is stacked on the undercoat layer 55. A stacked body including the undercoat layer 55 and the particle layer constituted by the second particles 56 corresponds to the low-refractive-index layer according to an embodiment of the present invention. Furthermore, projections 52 are formed on the surface of the optical member according to this embodiment.

The first particles 53 in the undercoat layer 55 have a monolayer structure formed on the base 50. The undercoat layer 55 further includes, in addition to the plurality of first particles 53, a filler 54 that is disposed in spaces between the first particles 53 and the base 50 and has a refractive index lower than or equal to that of the base 50. The filler 54 does not completely cover the first particles 53 and is formed so that at least part of surfaces of the first particles 53 is exposed. The refractive index of the first particles 53 is lower than or equal to that of the base 50. Therefore, the refractive index of the undercoat layer 55 is lower than that of the base 50.

The particle layer containing the plurality of second particles 56 is formed on the undercoat layer 55 so as to follow the shape of the surface of the undercoat layer 55. As a result, an uneven structure shown in FIG. 7 is formed on the surface of the optical member.

By employing the above-described structure, the optical member according to an embodiment of the present invention is provided so that the refractive index of the optical member substantially decreases in a direction from the base 50 toward the surface. Therefore, the reflectance can be reduced compared with a structure including only the base 50. Furthermore, since the projections 52 on the surface of the optical member satisfy the conditions 1 to 3, an optical member having high strength and a good dustproof property can be provided.

The same base as in the first and second embodiments can be used as the base 50:

As described above, the undercoat layer 55 includes the plurality of first particles 53 and the filler 54. The thickness of the undercoat layer 55 is equal to the particle diameter of the first particles 53. The refractive index of the undercoat layer 55 is lower than or equal to that of the base 50. An uneven structure is formed on the surface of the undercoat layer 55 so as to follow the shape of the first particles 53.

The first particles 53 have a monolayer structure formed on the base 50 and have a refractive index lower than or equal to that of the base 50. The refractive index of the first particles 53 can be higher than or equal to that of the second particles 56 for the purpose of improving the antireflection performance. The particle diameter of the first particles 53 can be 100 nm or more and 200 nm or less. If the particle diameter is less than 100 nm, the substantial refractive index on the surface of the optical member changes rapidly, which degrades the antireflection performance. When the particle diameter is 100 nm or more, the pitch of the uneven structure on the outermost surface increases and the number of contact points (contact area) with dust decreases, thereby improving the dustproof property. If the particle diameter is more than 200 nm, such an optical member is not suitable because scattering is considerably caused by the optical member and the haze is increased to about 10%. Note that projections 52 that satisfy the conditions 1 to 3 can be provided by selecting the particle diameter of the first particles 53 and the particle diameter of the second particles 56 described below.

The material of the first particles 53 is not particularly limited as long as the refractive index and particle diameter of the first particles 53 are within the above ranges. Examples of the first particles 53 include particles of silicon oxide, aluminum oxide, titanium oxide, zirconium oxide, zinc oxide, cerium oxide, and yttrium oxide and particles of a combination of two or more of the foregoing oxides. Other examples of the first particles 53 include particles of polystyrene, silicone, nylon, polypropylene, polyethylene terephthalate, styrene acrylic resin, polyimide, and polylactic acid. To achieve a lower refractive index, the first particles 53 may be hollow particles or particles each having pores on the surface thereof. Specifically, particles having a structure including pores with a size of 1 nm or more and 10 nm or less or particles (hollow particles) having a hollow structure may be used.

A monolayer of the first particles 53 is suitably stacked on the base 50 by spin coating, dip coating, capillary coating, or the like. Specifically, a monodispersed stable colloidal solution of the first particles 53 is prepared and applied onto the base 50 by the above method. The first particles 53 in the applied colloidal solution are densely aggregated with the volatilization of a solvent. Consequently, a monolayer of the first particles 53 is formed on the base 50. The concentration and viscosity of the colloidal solution are adjusted on the basis of the above coating method.

In order to stably disperse the first particles 53 in the colloidal solution, the chemical state of the surfaces of the first particles 53 may be changed by modifying the surfaces. Specifically, surfaces of inorganic oxide particles may be subjected to organic modification with a silane coupling agent or the like.

A Langmuir-Blodgett method can also be suitably used as a method for stacking a monolayer of the first particles 53 on the base 50. A colloidal solution is added dropwise to a liquid phase in a developing tank to form a monolayer of the first particles 53 at an interface between the liquid phase of the developing tank and a gaseous phase. Furthermore, the base 50 is dipped into the developing tank to transfer the monolayer of the first particles 53 onto the base 50. Thus, the monolayer of the first particles 53 can be formed on the base 50.

At least spaces formed between the plurality of first particles 53 and the base 50 are filled with the filler 54. Since the spaces are filled, the scattering of the optical member is suppressed. Specifically, spaces from the base 50 to a height corresponding to the radius of the first particles 53 may be filled with the filler 54. Spaces from the base 50 to a height larger than the height corresponding to the radius may be filled with the filler 54. However, to achieve a good dustproof property, the surfaces of the first particles 53 are exposed and an uneven structure needs to be formed on the surface of the undercoat layer 55.

The refractive index of the filler 54 is lower than or equal to that of the base 50. Since the antireflection performance further improves as the refractive index gradually increases in a direction from the surface of the optical member toward the base 50, the refractive index of the filler 54 is preferably higher than or equal to the refractive index of the second particles 56 and more preferably higher than or equal to the refractive index of the first particles 53.

The material of the filler 54 is not particularly limited as long as the refractive index is within the above range. For example, the filler 54 is composed of a monomer, a dimer, an organic polymer of at least a trimer, or an inorganic polymer prepared by a sol-gel process. Examples of the organic polymer include acrylic acid esters, methacrylic acid esters and derivatives thereof, and epoxy resins. The filler 54 may also be composed of an inorganic material prepared by a sol-gel process. A specific example of the inorganic material is silicon oxide. Other examples of the inorganic material include materials obtained by combining a high-refractive-index material such as aluminum oxide, titanium oxide, or zirconium oxide with a low-refractive-index material such as silicon oxide or magnesium fluoride. A polymer having a low degree of polymerization can also be suitably used as a filler 54 that provides ease of filling and ease of control of a filling factor.

The filler 54 can be suitably caused to enter the spaces between the first particles 53 and the base 50 by a known filling method such as dip coating, spin coating, spraying, or a combination of the foregoing. A method for depositing the filler 54 can also be employed. A solvent for adjusting viscosity and surface tension may be added to the filler 54 in order to cause the filler 54 to easily enter the spaces between the first particles 53 and the base 50. The filling may be performed in a hermetically sealed container under degassing in order to cause the filler 54 to forcibly enter the spaces between the first particles 53 and the base 50. When the filler 54 contains an organic material, a silane coupling agent may be added to the filler 54 to increase the adhesiveness to the base 50.

To adjust the refractive index of the filler 54, a filler obtained by combining a plurality of materials having different refractive indices may be used as the filler 54. Furthermore, a filler obtained by combining various materials may be used as the filler 54 so that the filler 54 has a plurality of functions.

After the spaces between the first particles 53 and the base 50 are filled with the filler 54, the filler 54 can be cured for fixation. When the filler 54 is composed of a thermosetting material, the filler 54 is cured by applying heat. When the filler 54 is composed of a photo-curable material, the filler 54 is cured by adding a photoinitiator and applying light.

The particle layer containing the second particles 56 is formed on the undercoat layer 55 (first particles 53) so as to follow the uneven structure shaped by the first particles 53 of the undercoat layer 55. The refractive index of the second particles 56 is lower than or equal to that of the first particles 53. The particle diameter of the second particles 56 is smaller than that of the first particles 53, and can be 10 nm or more and 50 nm or less in terms of improvement in a dustproof property. A plurality of the second particles 56 can be stacked on one of the first particles 53. When 60% or more of the area of the undercoat layer 55 is covered with the second particles 56, a substantially-inclined-refractive-index structure is formed, which can achieve a low reflectance and a good dustproof property.

The material of the second particles 56 is not particularly limited as long as the refractive index and particle diameter of the second particles 56 are within the above ranges. Examples of the second particles 56 include particles of silicon oxide, aluminum oxide, titanium oxide, zirconium oxide, zinc oxide, cerium oxide, and yttrium oxide and particles of a combination of two or more of the foregoing oxides. Other examples of the second particles 56 include particles of polystyrene, silicone, nylon, polypropylene, polyethylene terephthalate, styrene acrylic resin, polyimide, and polylactic acid. To achieve a lower refractive index, the second particles 56 may be hollow particles or particles each having pores on the surface thereof. Specifically, particles having a structure including pores with a size of 1 nm or more and 10 nm or less or hollow particles may be used.

The particle layer containing the plurality of second particles 56 is suitably stacked on the undercoat layer 55 by spin coating, dip coating, capillary coating, or the like. Specifically, a monodispersed stable colloidal solution of the second particles 56 is prepared and applied onto the undercoat layer 55 by the above method. The second particles 56 in the applied colloidal solution are densely aggregated with the volatilization of a solvent. Consequently, a particle layer containing the second particles 56 is formed on the undercoat layer 55. The concentration and viscosity of the colloidal solution are adjusted on the basis of the above coating method.

In order to stably disperse the second particles 56 in the colloidal solution, the chemical state of the surfaces of the second particles 56 may be changed by modifying the surfaces. Specifically, surfaces of inorganic oxide particles may be subjected to organic modification with a silane coupling agent or the like.

The particle layer may have a monolayer structure of the second particles 56 or a multi-layer structure of the second particles 56 as long as the uneven structure formed by the first particles 53 is reflected.

In order to increase the physical strength of the optical member, a reinforcement for increasing the adhesiveness between the first particles 53 and the second particles 56 or between the second particles 56 may be added to the solution (colloidal solution) used when the second particles 56 are formed. Specific examples of the reinforcement include silane coupling agents, acrylic acid esters, methacrylic acid esters and derivatives thereof, and epoxy resins. The reinforcement may be applied by dip coating, spin coating, spraying, or the like after the application of the second particles 56, or a reinforcement in a gaseous state may be deposited after the application of the second particles 56. Alternatively, after the application of the second particles 56, the surfaces of the second particles 56 may be melted by applying heat at a certain temperature to bind adjacent second particles 56.

In addition to the members and structures described above, the optical member according to an embodiment of the present invention may further include layers for imparting various functions. For example, in order to impart water repellency, a water-repellent layer composed of a fluoroalkylsilane, an alkylsilane, or the like may be disposed on the outermost surface of the optical member. Herein, the water-repellent layer and other functional layers need to be disposed so that the shapes of the undercoat layer 55 and the second particles 56 are reflected on the outermost surface of the optical member.

In order to improve the adhesiveness between the base 50 and the undercoat layer 55, an adhesive layer or a primer layer may be disposed therebetween. In addition, an intermediate layer having a refractive index between refractive indices of the base 50 and the undercoat layer 55 may be disposed between the base 50 and the undercoat layer 55. The intermediate layer may have a monolayer structure or a multi-layer structure. The refractive index of the intermediate layer can be gradually decreased in a direction from the base 50 toward the undercoat layer 55 in terms of improvement in antireflection performance.

The optical member according to an embodiment of the present invention may be optical members used in various displays for television sets and computers, polarizing plates for liquid crystal displays, viewing lenses for cameras, prisms, fly-eye lenses, and toric lenses and may also be various lenses used in image-taking optical systems using these optical members, optical systems for observation, such as binoculars, projection optical systems for liquid crystal projectors, and scanning optical systems for laser-beam printers.

### Fourth Embodiment

The optical member according to an embodiment of the present invention may be used in image pickup apparatuses such as digital cameras and digital video cameras. In particular, the optical member according to an embodiment of the present invention can be effectively used in image pickup apparatuses, for example, as a low-pass filter. In optical filters such as low-pass filters, it is important to impart a dustproof property to one filter located at the outermost surface. Therefore, a plurality of filters are not used and the margin of scattering required for each optical member is large. Furthermore, since many of such optical filters have a shape without a radius of curvature, scattering due to oblique incidence hardly becomes problematic. Therefore, even if projections having a size that can provide a good dustproof property are formed, scattering causes no problems. Thus, an image pickup apparatus including the optical member according to an embodiment of the present invention has a good dustproof property while hardly causing scattering.

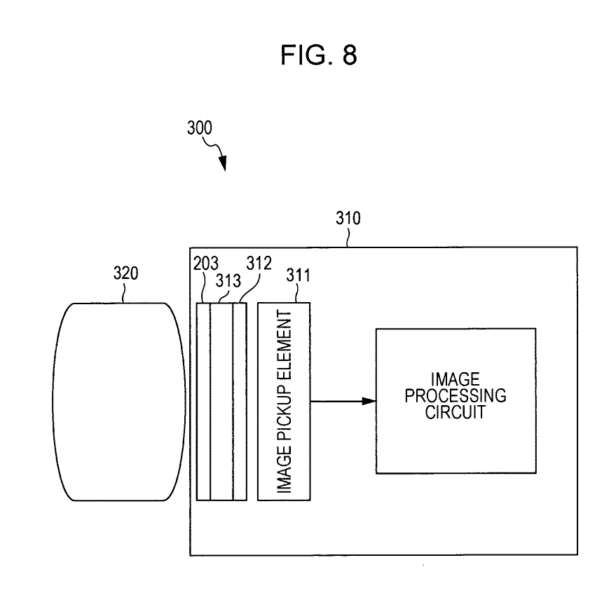

FIG. 8 is a schematic sectional view showing a camera (image pickup apparatus) including the optical member according to an embodiment of the present invention, more specifically, an image pickup apparatus configured to form an object image on an image pickup element through a lens and an optical filter.

An image pickup apparatus 300 includes a main body 310 and a detachable lens 320. An image pickup apparatus, such as a digital single-lens reflex camera, can take images at various view angles by replacing an image-taking lens to other image-taking lenses having different focal lengths. The main body 310 includes an image pickup element 311, an infrared cut filter 312, a low-pass filter 313, and an optical member 203 according to an embodiment of the present invention. The optical member 203 includes the base 100 and the low-refractive-index layer 101 as shown in FIG. 1.

The optical member 203 and the low-pass filter 313 may be integrally disposed or separately disposed. The optical member 203 may also serve as a low-pass filter. That is, the base 100 of the optical member 203 may be a low-pass filter.

The image pickup element 311 is accommodated in a package (not shown) while being hermetically sealed with a cover glass (not shown). The space between the optical filters, such as the low-pass filter 313 and the infrared cut filter 312, and the cover glass is hermetically sealed with a sealing member such as a double-sided tape (not shown). Although the case where the optical filter includes both the low-pass filter 313 and the infrared cut filter 312 is described, the optical filter may be one of the low-pass filter 313 and the infrared cut filter 312.

Since the optical member 203 according to an embodiment of the present invention has an uneven structure near its surface, the optical member 203 is highly dustproof, for example, it is capable of preventing dust adhesion.

Thus, the optical member 203 is disposed on the optical filter so as to be located on the side opposite to the image pickup element 311. The optical member 203 is disposed so that the low-refractive-index layer 101 is farther from the image pickup element 311 than the base 100. In other words, the optical member 203 can be disposed so that the base 100 and the low-refractive-index layer 101 are located in that order from the image pickup element 311 side. The optical member 203 and the image pickup element 311 are disposed so that an image that has passed through the optical member 203 can be taken by the image pickup element 311.

The image pickup apparatus 300 according to an embodiment of the present invention may include a dust-removing device (not shown) for removing dust by generating vibration or the like. The dust-removing device includes, for example, a vibrating member and a piezoelectric element.

The dust-removing device may be disposed at any position between the image pickup element 311 and the optical member 203. For example, the vibrating member may be disposed so as to be in contact with the optical member 203, the low-pass filter 313, or the infrared cut filter 312. In particular, when the vibrating member is disposed so as to be in contact with the optical member 203, dust can be more efficiently removed because dust does not easily adhere to the optical member 203 according to an embodiment of the present invention.

The vibrating member of the dust-removing device may be provided integrally with an optical filter such as the optical member 203, the low-pass filter 313, or the infrared cut filter 312. The vibrating member may be constituted by the optical member 203 or may have a function of the low-pass filter 313, the infrared cut filter 312, or the like.

### EXAMPLES

Examples will be described below, but the present invention is not limited to Examples.

Example 1 corresponds to the first embodiment. Examples 2 to 5 correspond to the second embodiment. Examples 6 and 7 correspond to the first embodiment and the second embodiment. Example 8 corresponds to the third embodiment.

### Preparation Example of Glass Powder Particles

A mixed powder of quartz powder, boron oxide, sodium oxide, and alumina having a composition of SiO₂ 63 wt %, B₂O₃27 wt %, Na₂O 7 wt %, and Al₂O₃ 3 wt % was melted in a platinum crucible at 1500° C. for 24 hours. The resulting glass was cooled to 1300° C. and was poured into a graphite mold. The glass was cooled in the air for about 20 minutes, placed in a lehr at 500° C. for 5 hours, and then cooled for 24 hours to obtain a glass body. The glass body was crushed with a jet mill until the average particle diameter of the particles reached 2.1 μm to prepare glass powder particles.

### Preparation Example of Glass Paste

Glass powder particles prepared above: 60.0 parts by mass

α-terpineol: 44.0 parts by mass

Ethylcellulose (registered trademark) ETHOCEL Std 200 (manufactured by The Dow Chemical Company): 2.0 parts by mass

These raw materials were mixed under stirring to prepare a glass paste.

### Example 1

In Example 1, a structure including a porous layer on a base was produced as follow. The glass paste was applied by screen printing onto a 50 mm×50 mm quartz base having a thickness of 0.5 mm (manufactured by Iiyama Precision Glass Co., Ltd.). A printer MT-320TV manufactured by Micro-tec Co., Ltd. was used. A #500 30 mm×30 mm solid image was used as a screen printing plate.

Subsequently, the quartz base with the glass paste was placed in a drying furnace at 100° C. for 10 minutes to evaporate the solvent, thereby forming a glass powder layer on the base. In a heat treatment process 1, the glass powder layer was heated to 1000° C. at a heating rate of 50° C./min, heat-treated for 5 minutes, and cooled to normal temperature at a cooling rate of 20° C./min to obtain a mother glass layer on the base. As a result of visual observation of the mother glass layer, the glass powder layer was sufficiently fused and was a transparent layer.

In the subsequent heat treatment process 2, the mother glass layer was heated to 600° C. at a heating rate of 20° C./min, heat-treated for 50 hours, and cooled to normal temperature at a cooling rate of 20° C./min to obtain a phase-separated glass layer on the base. The outermost surface of the phase-separated glass layer was then polished.

The stacked body of the base and the phase-separated glass layer was immersed into a 1.0 mol/L aqueous nitric acid solution heated to 95° C. and left to stand at 95° C. for 24 hours. The stacked body was then immersed in distilled water heated to 95° C. and left to stand for 3 hours. The stacked body was extracted from the solution and dried at room temperature (20° C.) for 12 hours to obtain a sample.

As a result of SEM observation of the obtained sample, an uneven structure was formed on the surface of the sample. In a cross section parallel to the base at a depth of 15 nm from the highest peak in a direction toward the base, the occupied area percentage of projections was 3%. The average of minor axis lengths of the projections at a depth of 5 nm or more and 15 nm or less from the highest peak in a direction toward the base was 20 nm.

### Comparative Example 1

In Comparative Example 1, a sample was produced in the same manner as in Example 1, except that the temperature of the solution into which the stacked body of the base and the phase-separated glass layer was immersed was changed to 80° C.

As a result of the observation of the sample, an uneven structure was formed on the surface of the sample. However, in a cross section parallel to the base at a depth of 15 nm from the highest peak in a direction toward the base, the occupied area percentage of projections was 100%. Furthermore, depressions were not formed at a depth larger than 10 nm from the highest peak in a direction toward the base. Therefore, the average of minor axis lengths of the projections at a depth of 5 nm or more and 10 nm or less was measured. The average was 49 nm.

### Preparation of Binder Solution 1

After 3.3 g of ethyl silicate (special grade, manufactured by KISHIDA CHEMICAL Co., Ltd.) and 1.5 g of ethyl cellosolve (special grade, manufactured by KISHIDA CHEMICAL Co., Ltd.) were mixed, the resulting mixture was stirred at normal temperature for 4 hours to prepare a solution A. After 4.3 g of a 0.01 mol/L aqueous hydrochloric acid solution (manufactured by KISHIDA CHEMICAL Co., Ltd.) and 0.9 g of ethyl cellosolve (special grade, manufactured by KISHIDA CHEMICAL Co., Ltd.) were mixed, the resulting mixture was stirred at normal temperature for 4 hours to prepare a solution B. The solution B was added to the solution A, and stirring was performed for 1 hour to prepare a solution C. The solid content of the solution C when all the silicon components contained in the solution C are assumed to be converted into silica was 9.6 wt %.

An appropriate amount of ethyl cellosolve was added to the solution C to prepare a binder solution 1 having a solid content of 2.4 wt %.

### Preparation of Binder Solution 2

A binder solution 2 was prepared by the same method as in the binder solution 1, except that an appropriate amount of ethyl cellosolve was added to the solution C so that the solid content of the binder solution 2 was 4.8 wt %.

### Preparation of Binder Solution 3

A binder solution 3 was prepared by the same method as in the binder solution 1, except that ethyl cellosolve was not added to the solution C. The solid content of the binder solution 3 was 9.6 wt %.

### Preparation of Binder Solution 4

A binder solution 4 was prepared by the same method as in the binder solution 1, except that an appropriate amount of ethyl cellosolve was added to the solution C so that the solid content of the binder solution 4 was 1.2 wt %.

### Preparation of Particle-Dispersed Solution 1

A hollow silica particle-dispersed solution (trade name: Sluria 1110, manufactured by JGC Catalysts and Chemicals Ltd.) having an average particle diameter of 50 nm was diluted with an ethyl cellosolve (special grade, manufactured by KISHIDA CHEMICAL Co., Ltd.) solvent so that the particle solid content was 10.0 wt %. Thus, a particle-dispersed solution 1 was prepared.

### Preparation of Particle-Dispersed Solution 2

A particle-dispersed solution 2 was prepared in the same manner as in the particle-dispersed solution 1, except that dilution was performed so that the particle solid content was 8.0 wt %.

### Preparation of Particle-Dispersed Solution 3

A particle-dispersed solution 3 was prepared in the same manner as in the particle-dispersed solution 1, except that dilution was performed so that the particle solid content was 4.0 wt %.

### Preparation of Coating Solution 1

The binder solution 1 and the particle-dispersed solution 1 were mixed at a weight ratio of 1:1 to prepare a coating solution 1 in which the solid content of the binder component was 1.2% and the particle solid content was 5.0%.

### Preparation of Coating Solutions 2 to 5

Coating solutions 2 to 5 were prepared in the same manner as in the coating solution 1, except that the binder solutions and particle-dispersed solutions listed in Table 1 were used.

TABLE 1

| | Coating | Coating | Coating | Coating | Coating |
|---|---|---|---|---|---|
| | solution 1 | solution 2 | solution 3 | solution 4 | solution 5 |
| Type of | Binder | Binder | Binder | Binder | Binder |
| binder | solution 1 | solution 1 | solution 2 | solution 2 | solution 3 |
| solution | | | | | |
| Type of | Particle- | Particle- | Particle- | Particle- | Particle- |
| particle- | dispersed | dispersed | dispersed | dispersed | dispersed |
| dispersed | solution 1 | solution 2 | solution 1 | solution 2 | solution 1 |
| solution | | | | | |

### Example 2

The coating solution 1 was applied dropwise to a quartz base (refractive index: 1.54). The rotational speed of the quartz base was increased to 4000 rpm in three seconds, spin coating was performed for 30 seconds, and the rotational speed was decreased to 0 rpm in three seconds.

Subsequently, the coating solution 1 was dried using a hot plate at 150° C. for 10 minutes and then heat-treated at 300° C. for 1 hour to convert the binder component into silica. Thus, a sample was produced.

As a result of SEM observation of the sample, an uneven structure was formed on the surface of the sample.

### Examples 3 to 5

A sample was produced in the same manner as in Example 2, except that the coating solution listed in Table 2 was used.

### Comparative Example 2

A sample was produced in the same manner as in Example 2, except that the coating solution listed in Table 2 was used.

### Comparative Example 3

The particle-dispersed solution 3 was applied dropwise to a quartz base (refractive index: 1.54). The rotational speed of the quartz base was increased to 4000 rpm in three seconds, spin coating was performed for 30 seconds, and the rotational speed was decreased to 0 rpm in three seconds. The particle-dispersed solution 3 was dried using a hot plate at 150° C. for 10 minutes.

The binder solution 1 was then applied dropwise to the sample. The rotational speed was increased to 4000 rpm in three seconds, spin coating was performed for 30 seconds, and the rotational speed was decreased to 0 rpm in three seconds.

The binder solution 1 was dried using a hot plate at 150° C. for 10 minutes and then heat-treated at 300° C. for 1 hour to convert the binder component into silica. Thus, a sample was produced.

### Comparative Example 4

A sample was produced in the same manner as in Comparative Example 3, except that the coating solution listed in Table 2 was used.

TABLE 2

| | | | | | | Comparative | Comparative | Comparative |
|---|---|---|---|---|---|---|---|---|
| | | Example 2 | Example 3 | Example 4 | Example 5 | Example 2 | Example 3 | Example 4 |
| Coating | Type of | Coating | Coating | Coating | Coating | Coating | — | — |
| solution | coating | solution 1 | solution 2 | solution 3 | solution 4 | solution 5 | | |
| | solution | | | | | | | |
| | Type of | Binder | Binder | Binder | Binder | Binder | Binder | Binder |
| | binder | solution 1 | solution 1 | solution 2 | solution 2 | solution 3 | solution 1 | solution 2 |
| | solution | | | | | | | |
| | Type of | Particle- | Particle- | Particle- | Particle- | Particle- | Particle- | Particle- |
| | particle- | dispersed | dispersed | dispersed | dispersed | dispersed | dispersed | dispersed |
| | dispersed | solution 1 | solution 2 | solution 1 | solution 2 | solution 1 | solution 3 | solution 3 |
| | solution | | | | | | | |
| | Particle | 50 | 50 | 50 | 50 | 50 | 50 | 50 |
| | diameter d | | | | | | | |
| | (nm) | | | | | | | |
| | Particle | hollow | hollow | hollow | hollow | hollow | hollow | hollow |
| | structure | | | | | | | |
| | Particle | 5.0 | 4.0 | 5.0 | 4.0 | 5.0 | 4.0 | 4.0 |
| | concentration | | | | | | | |
| | Cp (wt %) | | | | | | | |
| | Binder | 1.2 | 1.2 | 2.4 | 2.4 | 4.8 | 1.2 | 2.4 |
| | concentration | | | | | | | |
| | Cb (wt %) | | | | | | | |
| | Cp/Cb | 4.2 | 3.3 | 2.1 | 1.7 | 1.0 | 3.3 | 1.7 |

Tables 3 and 4 collectively show the occupied area percentage of projections and the average of minor axis lengths of projections of the samples in Examples 2 to 5 and Comparative Examples 2 to 4.

### Example 6

A 2-propanol (hereafter abbreviated as “IPA”) dispersion solution containing 30 wt % of silica particles having an average particle diameter of 15 nm and an aqueous solution containing 5.6 wt % of polyvinyl alcohol were mixed at a weight ratio of 1:10. The mixed solution was applied onto a quartz base by spin coating to form a film having a thickness of 150 nm. The film was heated to 700° C. at a heating rate of 10° C./h and then kept at 700° C. for 1 hour. The temperature was then decreased to room temperature to produce a sample.

### Example 7

A sample was produced in the same manner as in Example 6, except that silica particles having an average particle diameter of 80 nm were used.

Table 3 collectively shows the occupied area percentage of projections and the average of minor axis lengths of projections of the samples in Examples 6 and 7.

### Coating Solution 6

A coating solution 6 was produced by mixing 50 wt % of a 2-propanol (hereafter abbreviated as “IPA”) dispersion solution containing silica particles having an average particle diameter of 200 nm (trade name: Quartron PL-20-IPA, manufactured by FUSO CHEMICAL CO., LTD.) and 50 wt % of IPA.

### Filler Coating Solution

A perhydropolysilazane (hereafter abbreviated as “PHPS”) dibutyl ether solution (trade name: Aquamica NN-320-20, manufactured by AZ Electronic Materials) was diluted with a dibutyl ether solvent at a dilution factor of 15 to prepare a filler coating solution.

### Coating Solution 7

A coating solution 7 was produced by mixing 5 wt % of an IPA dispersion solution containing silica particles having an average particle diameter of 20 nm (trade name: IPA-ST-ZL, manufactured by Nissan Chemical Industries, Ltd.), 5 wt % of PVA, and 90% of pure water.

### Coating Solution 8

First, 17.2 g of aluminum isopropoxide, 4.56 g of 3-oxobutanoic acid ethyl ester, and 4-methyl-2-pentanol were uniformly mixed under stirring. Next, 1.26 g of 0.01 M dilute hydrochloric acid was dissolved in a mixed solvent of 4-methyl-2-pentanol/1-ethoxy-2-propanol and then slowly added to the solution of aluminum isopropoxide, and stirring was performed for a while. The solvent was prepared so as to be a mixed solvent containing 53.2 g of 4-methyl-2-pentanol and 22.8 g of 1-ethoxy-2-propanol in the end. Furthermore, stirring was performed in an oil bath at 120° C. for 3 hours or longer to produce a coating solution 8. The average particle diameter of fine particles in the coating solution 8 measured by dynamic light scattering was about 5 nm.

### Example 8

The coating solution 6 was applied dropwise to a quartz glass base, and spin coating was performed at 5000 rpm for 20 seconds. The coating solution 6 was then dried using a hot plate at 150° C. for 20 minutes.

The filler coating solution was applied dropwise to the quartz glass base, and spin coating was performed at 3000 rpm for 20 seconds. Subsequently, the sample was irradiated with ultraviolet rays for 10 minutes using an ultraviolet lamp to convert the PHPS into silica. The application of the filler coating solution and the silica conversion were repeatedly performed three times to form an undercoat layer on the base.

The coating solution 7 was applied dropwise to the undercoat layer, and spin coating was performed at 3000 rpm for 30 seconds. Subsequently, firing was performed using a hot plate at 400° C. for 1 hour to remove remaining solvents and PVA. Thus, a sample was produced.

As a result of SEM observation of the sample, a monolayer of silica particles having an average particle diameter of 200 nm was stacked on the quartz glass base. Silica particles having an average particle diameter of 20 nm were stacked on the surfaces of the silica particles having an average particle diameter of 200 nm. Spaces between the silica particles having an average particle diameter of 200 nm and the quartz glass base were filled with the PHPS.

### Comparative Example 5

A sample was produced in the same manner as in Example 8, except that the coating solution 8 was applied dropwise instead of the coating solution 7, spin coating was performed at 5000 rpm for 30 seconds, and firing was performed using a hot plate at 200° C. for 1 hour to remove remaining solvents and PVA.

Tables 3 and 4 collectively show the occupied area percentage of projections and the average of minor axis lengths of projections of the samples in Example 8 and Comparative Example 5.

### Comparative Example 6

An Evaporation Material OF-SR manufactured by Canon Optron. Inc. was deposited on a flat glass base to form a film having a thickness of about 3 nm to 6 nm. Table 4 shows the occupied area percentage of projections and the average of minor axis lengths of projections of the sample in Comparative Example 6.

### Evaluation of Characteristics

The following evaluations were performed for the samples in Examples 1 to 8 and Comparative Examples 1 to 6. Tables 3 and 4 show the results.

### 1. Evaluation of Adhesive Force

The adhesive force was measured with an atomic force microscope (hereafter abbreviated as “AFM”) (E-Sweep manufactured by Seiko Instruments Inc.). A cantilever (force model AFM probe cantilever: FM, manufactured by sQUBE) on which a polystyrene particle having a particle diameter of 6.1 μm is mounted was attached to the AFM, and measurement was conducted. A point at which the cantilever contacted a sample was assumed to be zero, and a scanner to which the sample was attached was lifted up by 200 nm to press the cantilever against the sample. The adhesive force was determined from a force curve observed when the cantilever was detached from the sample. In each measurement, 20 points were measured and the average of the measured adhesive forces was defined as an adhesive force exerted between the sample and the polystyrene particle. The measurement was performed at 25° C. and a humidity of 45%.

The adhesive force was expressed as an adhesive force index, which was a relative value when the adhesive force in Comparative Example 6 was assumed to be 1.00.

### 2. Evaluation of Reflectance

The reflectance of each of the samples in Examples and Comparative Examples at a wavelength of 550 nm at an incident angle of 00 in a visible region was measured with a Lens Spectral Reflectivity Measurement Device (USPM-RU manufactured by Olympus Corporation). The reason why reflectance at 550 nm was selected is that light with a wavelength of 550 nm is suitable for comparison of reflectance. This is because 550 nm is a center wavelength of a visible region (450 nm or more and 650 nm or less) and human beings are the most sensitive to light with a wavelength of near 550 nm.

### 3. Evaluation of Transmittance

The transmittance of each of the samples in Examples and Comparative Examples at a wavelength of 550 nm at an incident angle of 0° in a visible region was measured with an automatic optical element measurement device (V-570 manufactured by JASCO Corporation).

TABLE 3

| | Example 1 | Example 2 | Example 3 | Example 4 | Example 5 | Example 6 | Example 7 | Example 8 |
|---|---|---|---|---|---|---|---|---|
| Distance | 211 | 101 | 98 | 89 | 75 | 88 | 121 | 132 |
| between | | | | | | | | |
| projections | | | | | | | | |
| (nm) | | | | | | | | |
| Occupied | 3 | 30 | 21 | 23 | 29 | 3 | 2 | 2 |
| area | | | | | | | | |
| percentage | | | | | | | | |
| (%) | | | | | | | | |
| Average of | 20 | 23 | 24 | 19 | 28 | 17 | 40 | 32 |
| minor axis | | | | | | | | |
| lengths (nm) | | | | | | | | |
| Adhesive | 0.020 | 0.070 | 0.080 | 0.130 | 0.100 | 0.020 | 0.080 | 0.067 |
| force index | | | | | | | | |
| Reflectance | 0.20 | 0.20 | 0.30 | 0.51 | 0.32 | 0.09 | 0.67 | 2.14 |
| (%) | | | | | | | | |
| Transmittance | 93 | 95 | 95 | 95 | 95 | 95 | 95 | 94 |
| (%) | | | | | | | | |

TABLE 4

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| Distance | 62 | 200 | 146 | 123 | 156 | — |
| between | | | | | | |
| projections | | | | | | |
| (nm) | | | | | | |
| Occupied | 100 | 97 | 51 | 99 | 49 | 100 |
| area | | | | | | |
| percentage | | | | | | |
| (%) | | | | | | |
| Average of | 34 | 68 | 28 | 132 | 150 | — |
| minor axis | | | | | | |
| lengths (nm) | | | | | | |
| Adhesive | 0.750 | 0.830 | 0.321 | 1.100 | 0.559 | 1.000 |
| force index | | | | | | |
| Reflectance | 0.40 | 0.53 | 0.40 | 0.30 | 1.03 | 3.30 |
| (%) | | | | | | |
| Transmittance | 95 | 95 | 95 | 95 | 88 | 96 |
| (%) | | | | | | |

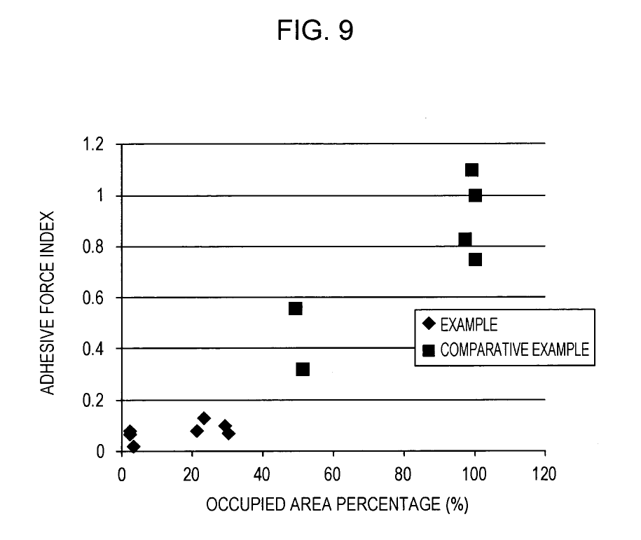

The adhesive force index of each of the samples in Examples is about 10% of the adhesive force index of the sample in Comparative Example 6, which means that a good dustproof property is achieved. FIG. 9 shows a relationship between the occupied area percentage of projections and the adhesive force index. As is clear from FIG. 9, the adhesive force indices in Examples are substantially the same. A curve of the adhesive force indices has an inflection point at an occupied area percentage of 40%, and the adhesive force indices are considerably low when the occupied area percentage is 40% or less.

It was also confirmed that, in each of the samples in Examples, an uneven structure was not broken even if the sample was touched with the hand.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-136160, filed Jun. 28, 2013, which is hereby incorporated by reference herein in its entirety.

### REFERENCE SIGNS LIST

100 base
101 low-refractive-index layer
102 projection

1. An optical member comprising:
a base; and
a porous glass layer disposed on the base and having a refractive index lower than that of the base,
wherein the porous glass layer has a plurality of projections on a surface opposite to a surface facing the base,
distance between peaks of two adjacent projections is 50 nm or more and 600 nm or less,
a percentage of a total cross-sectional area of the plurality of projections in a cross section parallel to the base at a depth of 15 nm from a peak farthest from the base in a direction toward the base per unit area is 40% or less, and
an average of minimum distances among distances of straight lines that extend between any two points on a circumference of a projection and that pass through a center point in a cross section of the projection is 15 nm or more, the distances of straight lines being obtained in each of a plurality of cross sections parallel to the base at a depth of 5 nm or more and 15 nm or less from the peak farthest from the base in the direction toward the base.

2. The optical member according to claim 1, wherein a pore size of the porous glass layer is 5 nm or more and 20 nm or less.

3. The optical member according to claim 1, wherein a skeleton size of the porous glass layer is 5 nm or more and 20 nm or less.

4. The optical member according to claim 1, wherein a porous structure of the porous glass layer is derived from spinodal phase separation.

5. The optical member according to claim 1, wherein an average of minimum distances among distances of straight lines that extend between any two points on a circumference of the projection and that pass through a center point in a cross section of the projection is 60 nm or less, the distances of straight lines being obtained in each of a plurality of cross sections parallel to the base at a depth of 5 nm or more and 15 nm or less from the peak farthest from the base in the direction toward the base.

6. An image pickup apparatus comprising:
the optical member according to claim 1; and
an image pickup element.

7. The optical member according to claim 1, wherein the porous glass layer contains boron oxide.

8. The optical member according to claim 1, wherein the base is quartz glass or rock crystal.

9. An optical member comprising:
a base; and
a porous glass layer having pores whose size is 5 nm or more and 20 nm or less, disposed on the base and having a refractive index lower than that of the base,
wherein the porous glass layer has a plurality of projections on a surface opposite to a surface facing the base, and
a distance between peaks of two adjacent projections is 50 nm or more and 600 nm or less.
